(19) United States
(12) Patent Application Publication
(10) Pub. No.: US 2024/0268597 A1
(43) Pub. Date: Aug. 15, 2024

(54) Milk Frother

(71) Applicant: Join One Electric (Shenzhen) Co., Ltd, Guang Dong (CN)

(72) Inventor: Yu-Lung Lin, Tainan City (TW)

(21) Appl. No.: 18/168,307

(22) Filed: Feb. 13, 2023

(51) Int. Cl. A47J 31/44; B01F 25/312

(52) U.S. Cl. CPC A47J 31/4485; B01F 25/31242; B01F 2101/07

(57) ABSTRACT

A milk frother includes a frother including a first chamber having a first inlet, a second inlet, a third inlet, and a first outlet. A steam coupling head is received in the first inlet of the frother. An air input guiding tube protrudes outwards from a location of the second inlet and includes a second chamber. An output device is coupled with the first outlet. An adjusting rod is pivotably connected to the air input guiding tube. A pad is disposed on a bottom face of the second chamber and includes a fourth inlet aligned with the second inlet. An adjusting valve is disposed in the second chamber, includes a spherical face abutting the pad, and is operatively coupled with the adjusting rod. A portion of the spherical face sealingly abuts a surface of the pad. The spherical face includes an air inlet groove having decreasing widths.

### BACKGROUND OF THE INVENTION

The present invention relates to a milk frother and, more particularly, to a device capable of stably adjusting frothing of milk.

To improve convenience in drinking coffee or other beverages, a machine capable of automatically brewing coffee or other beverages is generally used to enhance drinking convenience. Furthermore, a device for automatically frothing milk is provided to add milk foams into the coffee or various beverages, and different tastes can be provided according to the amount or fineness of the milk foams.

A conventional milk frother generally uses high pressure steam to mix with milk and air, and the ratio of air to milk can be adjusted to obtain milk foams of a proper fineness. However, adjustment of the air amount often requires complicated components, increasing the costs and malfunction rate of the components. Furthermore, the complicated components are difficult to assemble to reach desired airtightness, resulting difficulties in stable adjustment of the air amount and precise control of the fineness of the milk foams.

CN 103315631 discloses a milk frother including a frother, a rubber plug, an air adjusting rod, a milk suction tube, and a milk output tube. The frother includes an opening in an upper end thereof. A stop plate and a cover are disposed in the opening to prevent entrance of air resulting from backflow of milk. The rubber plug is cubic and disposed in the frother and includes an air inlet and an air outlet. The air adjusting rod is cylindrical and includes a tapering groove on an outer surface thereof for coupling with the air inlet for the purpose of adjusting the air input amount.

However, the above structure requires the stop plate, the cover, and the rubber plug with a relatively large volume, which results in an increase in the overall cost and the overall volume of the components. Furthermore, when the adjusting rod and the rubber plug cannot be stably coupled or the cover cannot seal the frother, the adjustment of the air input is unstable, and the quality of milk frothing is not good.

### BRIEF SUMMARY OF THE INVENTION

An objective of the present invention is to provide a milk frother which includes simple components and which is capable of stably adjusting the air input amount.

A milk frother according to the present invention comprises:

a frother including a first chamber, wherein the first chamber includes a first inlet, a second inlet, a third inlet, and a first outlet, wherein an air input guiding tube protrudes outwards from a location of the second inlet and includes a second chamber in a central portion thereof, and wherein the second chamber includes an air inlet in an end thereof opposite to the second inlet;

a steam coupling head received in the first inlet of the frother and configured to introduce high pressure steam into the first chamber;

an output device coupled with the first outlet of the frother, wherein the output device includes a connecting tube and an output tube, wherein an end of the connecting tube is coupled with the first outlet of the first chamber, wherein a central portion of the connecting tube includes a mixing groove, wherein a second outlet is disposed on a side of the mixing groove, and wherein the output tube intercommunicates with the second outlet; and

an adjusting device including an adjusting rod, a pad, and an adjusting valve, wherein the adjusting rod is pivotably connected to the air input guiding tube and extends perpendicularly to the air input guiding tube, wherein the pad is disposed on a bottom face of the second chamber and includes a fourth inlet aligned with the second inlet, wherein the adjusting valve is disposed in the second chamber and includes a spherical face on an outer side thereof, wherein the adjusting valve is operatively coupled with the adjusting rod, wherein a portion of the spherical face sealingly abuts a surface of the pad, wherein the spherical face of the adjusting valve includes an air inlet groove aligned with the fourth inlet and a rotating direction of the adjusting rod, and wherein the air inlet groove has decreasing widths.

In an example, the pad includes a semi-semispherical groove which surrounds the fourth inlet, faces the air inlet, and sealingly abuts a portion of the spherical face of the adjusting valve.

In an example, the pad is made of a material softer than the adjusting valve and is disposed between the bottom face of the second chamber and the adjusting valve.

In an example, the pad has a diameter approximately corresponding to a diameter of the second chamber.

In an example, a conic groove is disposed on a wall of the first chamber corresponding to the first outlet and has decreasing diameters towards the first outlet.

In an example, a pivotal peg and a coupling hole are disposed on opposite walls of the air inlet guiding tube and disposed in a direction perpendicular to the air inlet. The pivotal peg includes a pivotal groove. An end of the adjusting rod extends through the pivotal groove of the air input guiding tube and is pivotably coupled with the coupling hole.

The components of the present invention are simple, and the adjusting valve can stably abut the pad. Furthermore, the position of air inlet groove of the adjusting valve can be adjusted relative to the fourth inlet of the pad, thereby adjusting the air inlet amount. Thus, when high pressure steam is introduced via the steam coupling head, the steam, the milk, and external air introduced after adjustment are collected and mixed in the conic groove. The mixture is guided into the mixing groove to form milk foams after full mixing, and the milk foams are outputted via the second outlet and the output tube. Thus, milk foams with a preset fineness can be formed.

The present invention will become clearer in light of the following detailed description of illustrative embodiments of this invention described in connection with the drawings.

### DESCRIPTION OF THE DRAWINGS

FIG. 1 is an exploded, perspective view of a milk frother of an embodiment according to the present invention.

FIG. 2 is another exploded, perspective view of the milk frother of the embodiment according to the present invention.

FIG. 3 is a perspective view of the milk frother of the embodiment according to the present invention after assembly.

FIG. 4 is a cross sectional view of the milk frother of the embodiment according to the present invention, illustrating operation of the milk frother.

FIG. 5 is another cross sectional view of the milk frother of the embodiment according to the present invention, illustrating operation of the milk frother.

### DETAILED DESCRIPTION OF THE INVENTION

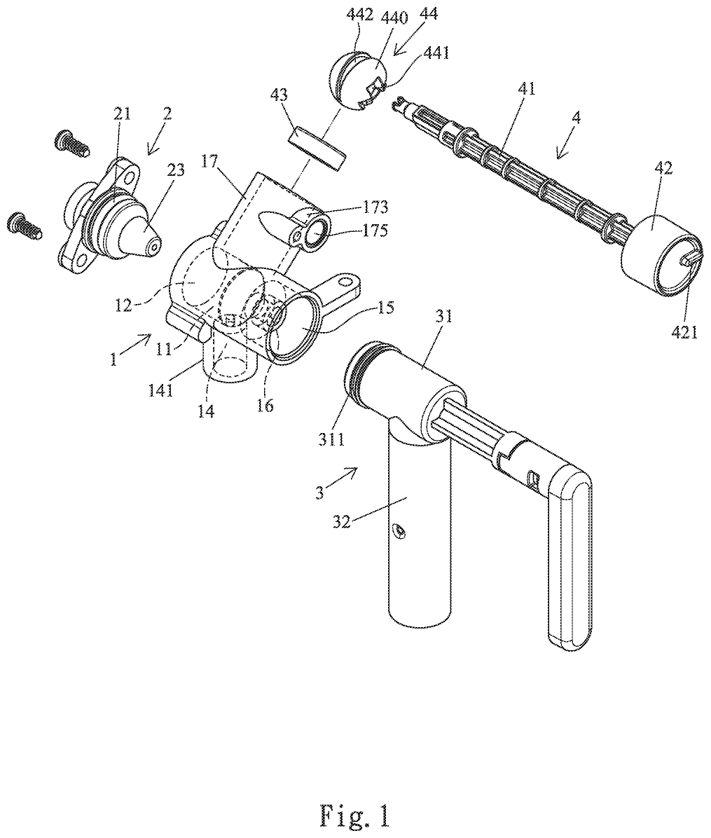

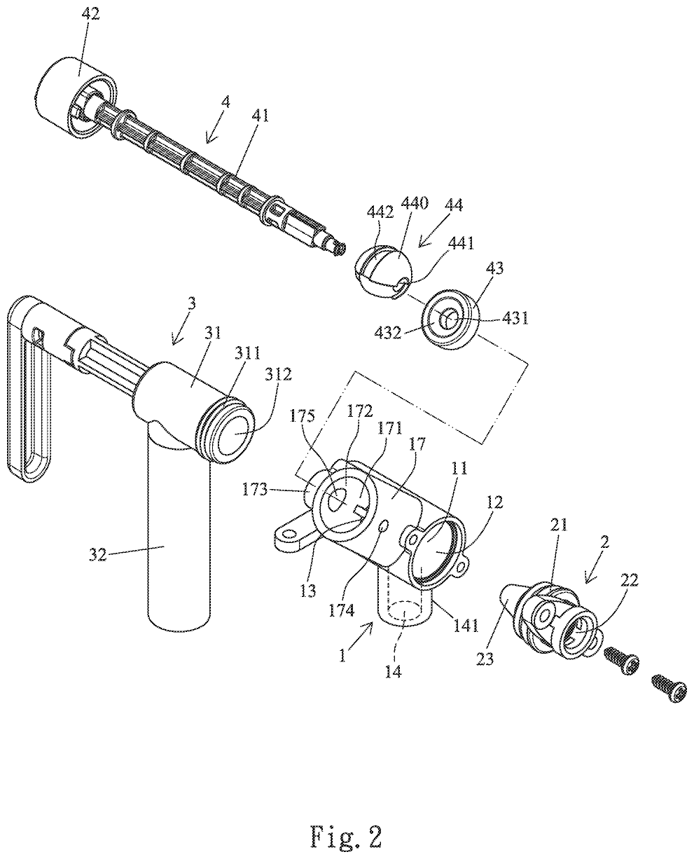

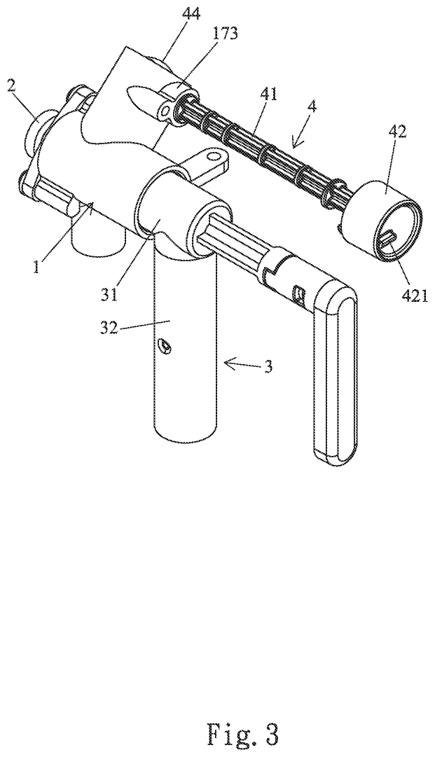

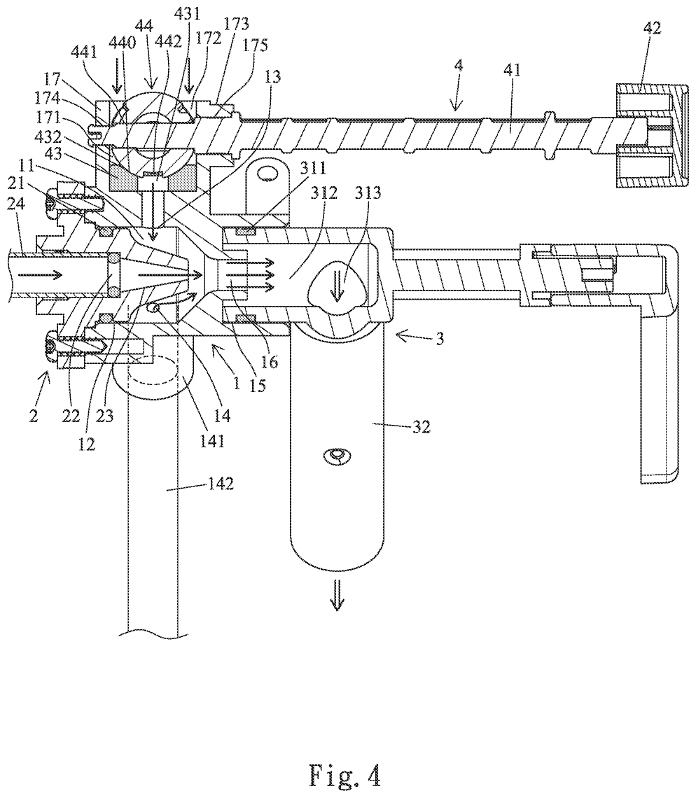

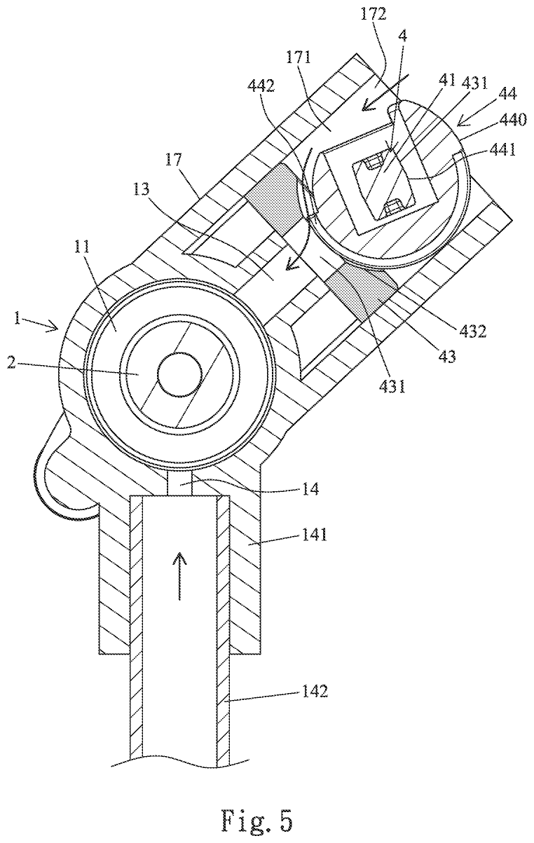

With reference to FIGS. 1-5, a milk frother of an embodiment according to the present invention comprises a frother 1, a steam coupling head 2, an output device 3, and an adjusting device 4. The milk frother 1 includes a first chamber 11. The first chamber 11 includes a first inlet 12, a second inlet 13, a third inlet 14, and a first outlet 15. The first inlet 12 and the first outlet 15 are axially aligned. A conic groove 16 is disposed on a wall of the first chamber 11 aligned with the first outlet 15 and has decreasing diameters towards the first outlet 15. An air input guiding tube 17 protrudes outwards from a location of the second inlet 13 and includes a second chamber 171 in a central portion thereof. The second chamber 171 includes an air inlet 172 in an end thereof opposite to the second inlet 13. A pivotal peg 173 and a coupling hole 174 are disposed on opposite walls of the air inlet guiding tube 17 and disposed in a direction perpendicular to the air inlet 172. The pivotal peg 173 includes a pivotal groove 175. An introducing tube 141 protrudes from a location of the third inlet 14 and is connected to a milk suction tube 142 for guiding milk into the first chamber 11.

The steam coupling head 2 is received in the first inlet 12 of the frother 1. An airtight ring 21 is disposed on an outer side of the steam coupling head 2 to be in airtight contact with an inner periphery of the first chamber 11. A steam guiding groove 22 is disposed in a central portion of the steam coupling head 2. A conic portion 23 is disposed on an end of the steam guiding groove 22 facing the conic groove 16 of the first chamber 1 and has decreasing diameters. Another end of the steam guiding groove 22 is connected to a steam guiding tube 24 to introduce high pressure steam from a coffee machine (not shown) or any other beverage dispenser.

The output device 3 is coupled with the first outlet 15 of the frother 1 and 3 includes a connecting tube 31 and an output tube 32. An end of the connecting tube 31 is coupled with the first outlet 15 of the first chamber 11. An airtight ring 311 is disposed around the connecting tube 31 and is in sealing contact with the inner periphery of the first chamber 11. A central portion of the connecting tube 31 includes a mixing groove 312 axially aligned with the conic groove 16. A second outlet 313 is disposed on a side of the mixing groove 312 remote from the frother 1. The output tube 32 intercommunicates with the second outlet 313.

The adjusting device 4 includes an adjusting rod 41, a knob 42, a pad 43, and an adjusting valve 44. An end of the adjusting rod 41 extends perpendicularly to the air input guiding tube 17, extends through the pivotal groove 175 of the air input guiding tube 17, and is pivotably coupled with the coupling hole 174, such that the adjusting rod 41 is pivotable relative to the air input guiding tube 17. The knob 42 is disposed on another end of the adjusting rod 41 and has a protrusive mark 421. The pad 43 is made of rubber or other soft material and has a diameter approximating the diameter of the second chamber 171. The pad 43 is disposed on the bottom face of the second chamber 171. After assembly, the pad 43 will not move in the second chamber 171 in a radial direction. Furthermore, the central portion of the pad 43 includes a fourth inlet 431 aligned with the second inlet 13. Furthermore, the pad 43 includes a semi-spherical groove 432 which surrounds the fourth inlet 431 and faces the air inlet 172. The adjusting valve 44 is made of a material harder than the pad 43 and is disposed in the second chamber 171. The adjusting valve 44 includes a spherical face 440 on an outer side thereof and a mounting hole 441 in a central portion thereof. An end of the adjusting rod 41 extends through the mounting hole 441 to provide an interlocking mechanism. A portion of the spherical face 440 is in sealing contact with the semi-spherical groove 432 of the pad 43. Furthermore, the pad 43 is sandwiched between the bottom face of the second chamber 171 and the adjusting valve 44 to avoid disengagement. Furthermore, the spherical face 440 includes an air inlet groove 442 aligned with the fourth inlet 431 and a rotating direction of the adjusting rod 41. The air inlet groove 442 has decreasing widths.

The pad 43 can be stably positioned. The semi-spherical groove 432 has a curvature for stable sealing contact with the spherical face 440 of the adjusting valve 44. The knob 42 can be rotated to adjust rotation of the adjusting valve 44 and the air inlet amount. Thus, the position of the air inlet groove 442 of the adjusting valve 44 can be adjusted relative to the fourth inlet 431 of the pad 43. When high pressure steam is introduced via the steam coupling head 2 into the steam guiding groove 22, the high pressure steam can be collected at the conic groove 16 and introduced into the first chamber 11. Furthermore, a negative pressure can be formed in the first chamber 11 to suck milk to pass through the milk suction tube 142 and the third inlet 14 into the first chamber 11. At the same time, external air is sucked to pass through into the air inlet 172, the air inlet groove 442, the fourth inlet 431, and the second inlet 13 and enter the first chamber 11. The steam, the milk, and the external air are collected and mixed in the conic groove 16 and then guided into the mixing groove 312 of the output device 3 to completely mix with each other, forming milk foams which are guided outwards via the second outlet 313 and the output tube 32. The second inlet 12, the first outlet 152, the conic groove 16, and the mixing groove 312 are axially disposed to enable the high pressure steam to flow in the same direction, further enhacning the guiding and mixing efficiency.

The present invention provides the pad 43 cooperating with the adjusting valve 44 to adjust the air input which simplifies the components. Furthermore, the adjusting valve 44 can be in stable sealing contact with the pad 43. Furthermore, the knob 42 can be turned to adjust the air inlet groove 442 of the adjusting valve 42 to a position corresponding to a proper width aligned with the fourth inlet 431. This enables easy, precise adjustment of the air inlet amount and the fineness of the milk foams while providing better movement stability. Furthermore, milk foams with a preset fineness can be formed to provide a better taste of the milk foams.

Although specific embodiments have been illustrated and described, numerous modifications and variations are still possible without departing from the scope of the invention. The scope of the invention is limited by the accompanying claims.

1. A milk frother comprising:
a frother including a first chamber, wherein the first chamber includes a first inlet, a second inlet, a third inlet, and a first outlet, wherein an air input guiding tube protrudes outwards from a location of the second inlet and includes a second chamber in a central portion thereof, and wherein the second chamber includes an air inlet in an end thereof opposite to the second inlet;
a steam coupling head received in the first inlet of the frother and configured to introduce high pressure steam into the first chamber;
an output device coupled with the first outlet of the frother, wherein the output device includes a connecting tube and an output tube, wherein an end of the connecting tube is coupled with the first outlet of the first chamber, wherein a central portion of the connecting tube includes a mixing groove, wherein a second outlet is disposed on a side of the mixing groove, and wherein the output tube intercommunicates with the second outlet; and
an adjusting device including an adjusting rod, a pad, and an adjusting valve, wherein the adjusting rod is pivotably connected to the air input guiding tube and extends perpendicularly to the air input guiding tube, wherein the pad is disposed on a bottom face of the second chamber and includes a fourth inlet aligned with the second inlet, wherein the adjusting valve is disposed in the second chamber and includes a spherical face on an outer side thereof, wherein the adjusting valve is operatively coupled with the adjusting rod, wherein a portion of the spherical face sealingly abuts a surface of the pad, wherein the spherical face of the adjusting valve includes an air inlet groove aligned with the fourth inlet and a rotating direction of the adjusting rod, and wherein the air inlet groove has decreasing widths.

2. The milk frother as claimed in claim 1, wherein the pad includes a semi-semispherical groove which surrounds the fourth inlet, faces the air inlet, and sealingly abuts a portion of the spherical face of the adjusting valve.

3. The milk frother as claimed in claim 1, wherein the pad is made of a material softer than the adjusting valve and is disposed between the bottom face of the second chamber and the adjusting valve.

4. The milk frother as claimed in claim 1, wherein the pad has a diameter approximately corresponding to a diameter of the second chamber.

5. The milk frother as claimed in claim 1, wherein a pivotal peg and a coupling hole are disposed on opposite walls of the air inlet guiding tube and disposed in a direction perpendicular to the air inlet, wherein the pivotal peg includes a pivotal groove, and wherein an end of the adjusting rod extends through the pivotal groove of the air input guiding tube and is pivotably coupled with the coupling hole.

6. The milk frother as claimed in claim 1, wherein the adjusting device further includes a knob disposed on an end of the adjusting rod, and wherein the knob has a protrusive mark.

7. The milk frother as claimed in claim 1, wherein a conic groove is disposed on a wall of the first chamber corresponding to the first outlet and has decreasing diameters towards the first outlet.

8. The milk frother as claimed in claim 7, wherein the first inlet, the first outlet, the conic groove, and the mixing groove are axially aligned.

9. The milk frother as claimed in claim 1, wherein an airtight ring is disposed around the connecting tube and is in sealing contact with an inner periphery of the first chamber.

10. The milk frother as claimed in claim 1, wherein the second outlet is located on a side of the mixing groove remote from the frother.
